(19) United States
(12) Patent Application Publication
(10) Pub. No.: US 2025/0128894 A1
(43) Pub. Date: Apr. 24, 2025

(54) PNEUMATIC CONVEYING SYSTEM AND OPTIMIZED CONFIGURATION METHOD

(71) Applicants: JIANGSU XCMG CONSTRUCTION MACHINERY RESEARCH INSTITUTE LTD., JIANGSU (CN); JIANGSU XCMG STATE KEY LABORATORY TECHNOLOGY CO.,LTD., JIANGSU (CN)

(72) Inventors: Yang LI, JIANGSU (CN); Xiaopei LI, JIANGSU (CN); Jianquan SANG, JIANGSU (CN); Haiqiang LI, JIANGSU (CN)

(73) Assignees: JIANGSU XCMG CONSTRUCTION MACHINERY RESEARCH INSTITUTE LTD., JIANGSU (CN); JIANGSU XCMG STATE KEY LABORATORY TECHNOLOGY CO., LTD., JIANGSU (CN)

(21) Appl. No.: 18/694,529

(22) PCT Filed: Sep. 27, 2023
(86) PCT No.: PCT/CN2023/122042

§ 371 Date: Mar. 22, 2024

(30) Foreign Application Priority Data
Nov. 25, 2022 (CN) 202211496399.8

(51) Int. Cl. B65G 53/66; B65G 53/52; B65G 53/58

(52) U.S. Cl. CPC B65G 53/66; B65G 53/523; B65G 53/58

(57) ABSTRACT

The present disclosure discloses a pneumatic conveying system and an optimized configuration method. The pneumatic conveying system uses a pressure-type elephant bionic trunk conveying pipeline to convey a material or uses a suction-type elephant bionic trunk conveying pipeline to convey a material, wherein the pressure-type elephant bionic trunk conveying pipeline is a pipeline with a gradually enlarged inner diameter, and the suction-type elephant bionic trunk conveying pipeline is a pipeline with a gradually reduced inner diameter.

### CROSS-REFERENCE TO RELATED APPLICATIONS

The present application is a U.S. National Stage Application under 35 U.S.C. § 371 of International Patent Application No. PCT/CN2023/122042, filed on Sep. 27, 2023, which is based on and claims priority to China Patent Application No. 202211496399.8 filed on Nov. 25, 2022, the disclosures of both of which are incorporated by reference herein in their entireties.

### TECHNICAL FIELD

The present disclosure relates to a pneumatic conveying system and an optimized configuration method, especially to an elephant bionic trunk long-distance pneumatic conveying system and an optimized configuration method.

### BACKGROUND

Pneumatic conveying is a means to transport powder and lump material, in which bulk material may be conveyed from one or more sources to one or more destinations along a set pipeline route by using high-speed flowing gas inside a conveying pipeline as a conveying medium. Due to a simple composition and with the characteristics such as low cost and convenient maintenance, a pneumatic conveying device is widely applied in industries such as agriculture, food, energy, chemical and environmental sanitation. According to the operational principle, pneumatic conveying systems can be divided into two types: pressure-type and suction-type. A pressure-type pneumatic conveying system performs conveying by pushing material using compressed air with a pressure higher than an atmospheric pressure, and a suction-type pneumatic conveying system suctions atmosphere and material together into a pipeline and performs conveying by using an airflow with a pressure lower than the atmospheric pressure, which is also referred to as vacuum suction.

### SUMMARY

An object of the present disclosure is to provide a pneumatic conveying system and an optimized configuration method, especially to an elephant bionic trunk long-distance pneumatic conveying system and an optimized configuration method. The conveying system uses a pipeline with gradational inner diameter (which may also be referred to as a tapered pipeline) as a conveying pipeline, which can reduce the resistance of gas flowing through the pipeline, thereby achieving an extension of a conveying distance without changing a power and fan system, or lowering the requirement for the performance of the power and fan system to reduce the energy consumption of the system without changing a conveying distance.

In order to achieve the above-described object, the present disclosure uses the following technical solutions.

In a first aspect of the present disclosure, a pneumatic conveying system is provided. The system comprises a first power unit, a first fan, a feeder, a pressure-type elephant bionic trunk conveying pipeline, a gas-material separator and a material storage tank, wherein the first power unit is configured to provide power for the first fan; the first fan is configured to convert kinetic energy provided by the first power unit into energy of gas flow in the pneumatic conveying system; an outlet of the first fan is connected to a second connection pipeline which is connected to the pressure-type elephant bionic trunk conveying pipeline, and the pressure-type elephant bionic trunk conveying pipeline is sequentially connected to the gas-material separator and the material storage tank; the feeder is located at connection of the second connection pipeline and the pressure-type elephant bionic trunk conveying pipeline; and the pressure-type elephant bionic trunk conveying pipeline is a pipeline with a gradually enlarged inner diameter, wherein one end with a smaller inner diameter of the pressure-type elephant bionic trunk conveying pipeline is connected to the feeder, and one end with a larger inner diameter of the pressure-type elephant bionic trunk conveying pipeline is connected to the gas-material separator.

In some embodiments, the first power unit is any of the following: an engine, a motor, and an electric motor.

In some embodiments, the first power unit is connected to the first fan through a coupling, a belt or a chain.

In some embodiments, the first fan is any of the following: a Roots blower, a centrifugal fan, and an axial flow fan.

In some embodiments, the pressure-type elephant bionic trunk conveying pipeline is spliced by pipelines with different inner diameters according to an ascending sequence in size, wherein a pipeline with a smallest inner diameter is a first conveying pipeline connected to the feeder, a pipeline with a largest inner diameter is a last conveying pipeline connected to the gas-material separator, and at least one conveying pipeline is between the first conveying pipeline and the last conveying pipeline.

In some embodiments, a transition pipeline in a tapered shape is provided at a diameter varying position between the pipelines with different inner diameters.

In some embodiments, the pneumatic conveying system further comprises a first muffler connected to the first fan through a first connection pipeline.

In a second aspect of the present disclosure, a pneumatic conveying system is provided. The system comprises a second power unit, a second fan, a dust collector, a negative-pressure material storage tank, a suction-type elephant bionic trunk conveying pipeline, and a suction nozzle, wherein the second power unit is configured to provide power for the second fan; the second fan is configured to convert kinetic energy provided by the second power unit into energy of gas flow in the pneumatic conveying system; an outlet of the second fan is sequentially connected to the dust collector and the negative-pressure material storage tank; the negative-pressure material storage tank is connected to the suction-type elephant bionic trunk conveying pipeline; the suction nozzle is provided at an end of the suction-type elephant bionic trunk conveying pipeline; and the suction-type elephant bionic trunk conveying pipeline is a pipeline with a gradually reduced inner diameter, wherein one end with a smaller inner diameter of the suction-type elephant bionic trunk conveying pipeline is connected to the suction nozzle, and one end with a larger inner diameter of the suction-type elephant bionic trunk conveying pipeline is connected to the negative-pressure material storage tank.

In some embodiments, the second power unit is any of the following: an engine, a motor, and an electric motor.

In some embodiments, the second power unit is connected to the second fan through a coupling, a belt or a chain.

In some embodiments, the second fan is any of the following: a Roots blower, a centrifugal fan, and an axial flow fan.

In some embodiments, the suction-type elephant bionic trunk conveying pipeline is spliced by pipelines with different inner diameters according to a descending sequence in size; wherein a pipeline with a largest inner diameter is a first conveying pipeline connected to the negative-pressure material storage tank; a pipeline with a smallest inner diameter is a last conveying pipeline connected to the suction nozzle; and at least one conveying pipeline is between the first conveying pipeline and the last conveying pipeline.

In some embodiments, a transition pipeline in a tapered shape is provided at a diameter varying position between the pipelines with different inner diameters.

In some embodiments, the pneumatic conveying system further comprises a second muffler connected to the second fan through a third connection pipeline.

In a third aspect of the present disclosure, an optimized configuration method of a pneumatic conveying system for performing an optimized configuration of the pipelines with different inner diameters in the aforementioned pneumatic conveying system is provided. The optimized configuration method comprises: step 1: determining a conveying distance of the pneumatic conveying system, a diameter of the first conveying pipeline, a diameter of the last conveying pipeline, a number of diameter varying times and a diameter of the at least one conveying pipeline; step 2: judging whether a transition pipeline is used at a diameter varying position between the pipelines with different inner diameters, proceeding to step 3 in a case where the transition pipeline is used, and proceeding to step 4 in a case where the transition pipeline is not used; step 3: calculating a length of the transition pipeline at the diameter varying position based on the diameter of each conveying pipeline in the at least one conveying pipeline, and proceeding to step 4; step 4: constructing a parametric fluid domain three-dimensional model of an elephant bionic trunk conveying pipeline formed by the pipelines with different inner diameters; step 5: griding the parametric fluid domain three-dimensional model constructed and setting a boundary condition for the parametric fluid domain three-dimensional model; and step 6: performing an optimization calculation on the parametric fluid domain three-dimensional model taking lengths of the pipelines with different inner diameters as variables and a uniformity index of a distribution field of gas flow rate in the elephant bionic trunk conveying pipeline as a target, to output the lengths of the pipelines with different inner diameters.

In some embodiments, the calculating a length of the transition pipeline at the diameter varying position based on the diameter of each conveying pipeline in the at least one conveying pipeline comprises: setting the length of the transition pipeline at the diameter varying position to be 6 times or more of a diameter of a conveying pipeline with a larger inner diameter in conveying pipelines connected to the transition pipeline at the diameter varying position.

In some embodiments, the performing an optimization calculation on the parametric fluid domain three-dimensional model comprises: performing the optimization calculation on the parametric fluid domain three-dimensional model by any of the following methods until the uniformity index of the distribution field of gas flow rate in the elephant bionic trunk conveying pipeline satisfies a preset requirement: Bayesian Optimization, genetic algorithm, gradient-based optimization, grid search, swarm-based optimization, ParamILS, and Keras Tuner.

In a fourth aspect of the present disclosure, a computer-readable storage medium comprising computer program instructions is provided, wherein the optimized configuration method according to any one of the above-described embodiments is implemented when the computer program instructions are executed by a processor.

In a fifth aspect of the present disclosure, a computer program product comprising a computer program is provided, wherein the optimized configuration method according to any one of the above-described embodiments is implemented when the computer program is executed by a processor.

### BRIEF DESCRIPTION OF THE ACCOMPANYING DRAWINGS

FIG. 1 is a schematic view of a pressure-type pneumatic conveying system provided by some embodiments of the present disclosure;

FIG. 2 is a schematic view of a pressure-type elephant bionic trunk conveying pipeline provided by some embodiments of the present disclosure;

FIG. 3 is a schematic view of a pressure-type elephant bionic trunk conveying pipeline spliced by pipelines with inner diameters in multiple specifications and varied two times provided by some embodiments of the present disclosure;

FIG. 4 is a schematic view of a suction-type pneumatic conveying system provided by other embodiments of the present disclosure;

FIG. 5 is a schematic view of a suction-type elephant bionic trunk conveying pipeline provided by other embodiments of the present disclosure;

FIG. 6 is a schematic view of a suction-type elephant bionic trunk conveying pipeline spliced by pipelines with inner diameters in multiple specifications and varied two times provided by other embodiments of the present disclosure;

FIG. 7 is a flow chart of an optimized configuration of an elephant bionic trunk conveying pipeline provided by still other embodiments of the present disclosure.

### DETAILED DESCRIPTION

Various exemplary embodiments of the present disclosure will now be described in detail with reference to the accompanying drawings. The description of the exemplary embodiments is merely illustrative and is in no way intended as a limitation to the present disclosure and its application or use. The present disclosure may be implemented in many different forms, which are not limited to the embodiments described herein. These embodiments are provided to make the present disclosure thorough and complete, and fully convey the scope of the present disclosure to those skilled in the art. It should be noticed that: relative arrangement of components and steps, material composition, numerical expressions, and numerical values set forth in these embodiments, unless specifically stated otherwise, should be explained as merely illustrative, and not as a limitation.

The use of “first”, “second” and similar words in the present disclosure do not denote any order, quantity or importance, but are merely used to distinguish between different parts. A word such as “comprise”, “include” or variants thereof means that the element before the word covers the element(s) listed after the word without excluding the possibility of also covering other elements. The words “up”, “down”, “left”, “right”, or the like are used only to represent a relative positional relationship, and the relative positional relationship may change correspondingly after the absolute position of the described object changes.

In the present disclosure, when it is described that a particular device is located between a first device and a second device, there may be an intermediate device between the particular device and the first device or the second device, or there may be no intermediate device between the particular device and the first device or the second device. When it is described that a particular device is connected to other devices, the particular device may be directly connected to the other devices without an intermediate device, or not directly connected to the other devices with an intermediate device.

Unless otherwise defined, all terms (comprising technical or scientific terms) used in the present disclosure have the same meanings as the meanings commonly understood by one of ordinary skill in the art to which the present disclosure belongs. It should also be understood that terms as defined in a general dictionary and so on, unless explicitly defined herein, should be interpreted as having meanings that are consistent with their meanings in the context of the relevant art, and not to be interpreted in an idealized or extremely formalized sense.

Techniques, methods, and apparatuses known to those of ordinary skill in the relevant art may not be discussed in detail, but where appropriate, these techniques, methods, and apparatuses should be considered as part of the specification.

With the gradual development and maturity of pneumatic conveying technology, people have begun to attempt to apply this technology to an operating condition for long-distance conveying. The key of whether long-distance pneumatic conveying can be successful lies in whether the power and fan system can provide enough power to maintain an adequate pressure difference between both ends of the conveying pipeline, so that the gas inside the pipeline can still flow orderly at a flow rate exceeding a suspension speed of the material being conveyed after overcoming the resistance when flowing inside the pipeline. Therefore, the following two technical solutions are usually used to realize long-distance pneumatic conveying: 1. enhancing the performance of the power and fan system to provide more robust power for the pneumatic conveying system; 2. optimizing the conveying pipeline to reduce the resistance of the gas when flowing in the pipeline. At present, the research work of most scholars focuses on the first solution. However, the technology related to the power and fan has been relatively mature, with a limited potential for further enhancing its performance and a high cost being required. There are also scholars carrying out the research work on the second technical solution, but most of which focuses on the material of the pipeline and the internal texture of the pipeline. At present, there is no relevant report on research of structure and dimension of the pipeline yet. In addition, due to compressibility of gas, the volume of gas will change greatly after a pressure change. Besides, there is a pressure difference between both ends of the pipeline, which results in uneven distribution of gas flow rate inside the conveying pipeline. In normal circumstances, gas flow rate at one end of the conveying pipeline is low, while gas flow rate at the other end is high (the condition of the distribution of gas flow rate inside the pressure-type and suction-type pipelines are opposite). A high flow rate will aggravate the wear of the pipeline and reduce the service life of the pneumatic conveying system. This phenomenon is especially prominent in long-distance pneumatic conveying.

The beneficial effects of the present disclosure are as follows:
(1) The pneumatic conveying system provided in the present disclosure (for example, the elephant bionic trunk long-distance pneumatic conveying system) conveys the material using a pressure-type elephant bionic trunk conveying pipeline with a gradually enlarged inner diameter or a suction-type elephant bionic trunk conveying pipeline with a gradually reduced inner diameter, which can achieve an extension of a conveying distance without changing the power and fan system, or lower the requirement for the performance of the power and fan system to reduce the energy consumption of the system without changing a conveying distance.
(2) The distribution of pneumatic flow rate inside the elephant bionic trunk long-distance pneumatic conveying pipeline provided in the present disclosure is more uniform, which can reduce the wear of the pipeline caused by high-speed flowing air and material to prolong a service life of the pneumatic conveying system.

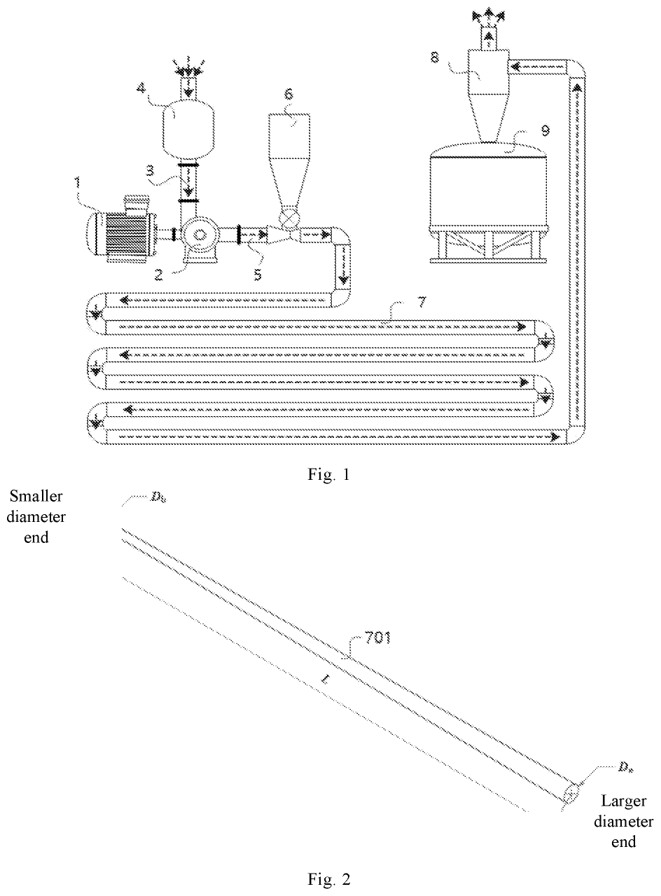

In some embodiments of the present disclosure, a pneumatic conveying system (for example, a pressure-type pneumatic conveying system, which may also be referred to as a pressure-type elephant bionic trunk long-distance pneumatic conveying system) is provided. As shown in FIG. 1, the pneumatic conveying system comprises a first power unit 1, a first fan 2, a first connection pipeline 3, a first muffler 4, a second connection pipeline 5, a feeder 6, a pressure-type elephant bionic trunk conveying pipeline 7, a gas-material separator 8 and a material storage tank 9.

Specifically, the first power unit 1 is configured to provide power for the first fan 2.

The first fan 2 is a power source of gas flow in the pneumatic conveying system and is configured to convert kinetic energy provided by the first power unit 1 into energy of gas flow in the pneumatic conveying system.

The first fan 2 is connected to the first muffler 4 through the first connection pipeline 3, and the first muffler 4 is configured to reduce the noise generated by the first fan 2.

The outlet of the first fan 2 is connected to the second connection pipeline 5, the second connection pipeline 5 is connected to the pressure-type elephant bionic trunk conveying pipeline 7, and the feeder 6 is located at connection of the second connection pipeline 5 and the pressure-type elephant bionic trunk conveying pipeline 7.

The feeder 6 is configured to provide the material to be conveyed for the pneumatic conveying system. The material, which enters the pressure-type elephant bionic trunk conveying pipeline 7 via the feeder 6, is carried by high-speed flowing gas, and conveyed to the gas-material separator 8 along a set pipeline route.

The gas-material separator 8 is connected to the material storage tank 9. The gas-material separator 8 is configured to separate a gas-material mixture, such that the gas is exhausted into the atmosphere after treatment, and the material enters the material storage tank 9.

The storage tank 9 is configured to store the material conveyed to a destination.

As some implementations, the first power unit 1 comprises, but is not limited to a power device such as an engine, a motor, or an electric motor, and can convert chemical energy, kinetic energy, electric energy, and the like into kinetic energy to drive the first fan 2 to rotate.

As some implementations, the first power unit 1 is connected to the first fan 2 through a coupling, a belt, a chain, and the like.

As some implementations, the first fan 2 comprises, but is not limited to, a Roots blower, a centrifugal fan, an axial flow fan, and the like.

As some implementations, the pressure-type elephant bionic trunk conveying pipeline 7, referring to FIG. 2 for its structure, is a pipeline 701 with a gradually enlarged inner diameter (for example, a pipeline in a shape similar to a tapered shape). The pipeline 701 may be arranged along a straight line as needed or may also be curvedly arranged along a conveying path. The pipeline 701 has one end with a smaller inner diameter connected to the feeder 6 and one end with a larger inner diameter connected to the gas-material separator 8. By using this structure, the inner diameter of the pipeline gradually enlarges, which can provide a larger flow space for the gas inside, alleviate or even offset an increase of gas flow rate caused by volumetric expansion of the gas due to a pressure drop, and alleviate or even offset a decrease of gas flow rate caused by volumetric compression of the gas due to a pressure rise.

As other implementations, the pressure-type elephant bionic trunk conveying pipeline 7 is spliced by pipelines with inner diameters in different standard specifications according to an ascending sequence in size, where a pipeline with the smallest diameter is connected to the feeder 6 and a pipeline with the largest diameter is connected to the gas-material separator 8. It should be understood that a pipeline with inner diameter in a certain standard specification has substantially constant inner diameter.

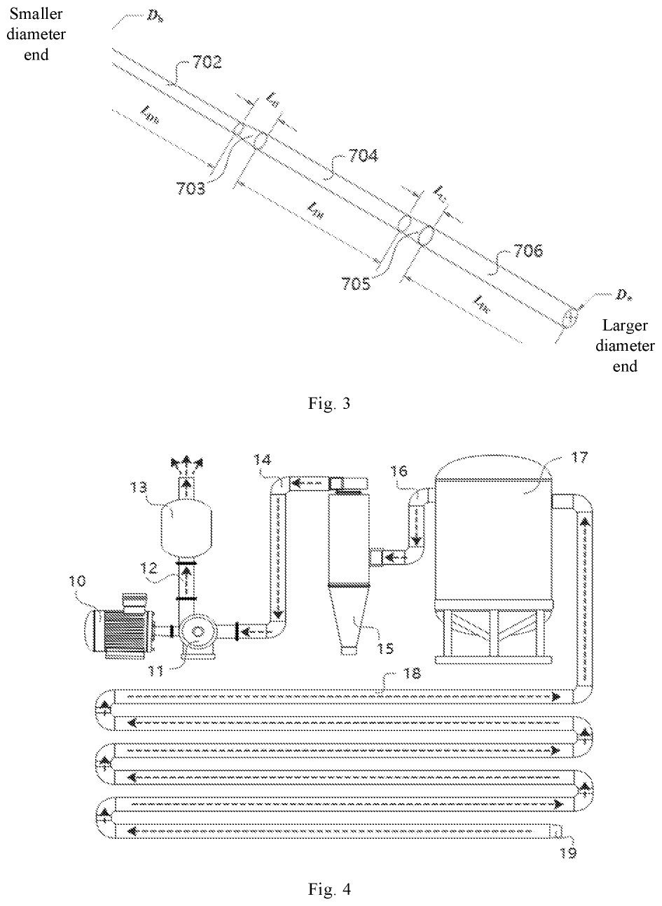

As other implementations, as the structure shown in FIG. 3, the pressure-type elephant bionic trunk conveying pipeline 7 is spliced by pipelines with inner diameters in different standard specifications according to an ascending sequence in size, and a transition pipeline in a tapered shape is provided between pipelines with inner diameters in different specifications. By adding the transition pipeline, the pipeline blockage caused by a sudden change of internal gas flow rate due to a sudden change of the inner diameter of pipelines can be alleviated.

FIG. 3 illustrates a case where the diameters varied two times as an example, which shall not serve as a limitation of the present disclosure.

Referring to FIG. 3, the pressure-type elephant bionic trunk conveying pipeline 7 is spliced by a first conveying pipeline 702, a conveying pipeline 704 and a last conveying pipeline 706 according to an ascending sequence in size. A first transition pipeline 703 in a tapered shape is provided at a diameter varying position between the first conveying pipeline 702 and the conveying pipeline 704, and a second transition pipeline 705 in a tapered shape is provided at a diameter varying position between the conveying pipeline 704 and the last conveying pipeline 706. It can be understood that the respective inner diameters of the first conveying pipeline 702, the conveying pipeline 704 and the last conveying pipeline 706 are substantially constant.

The first conveying pipeline 702 is connected to the feeder 6, and the last conveying pipeline 706 is connected to the gas-material separator 8.

In other embodiments of the present disclosure, a pneumatic conveying system (for example, a suction-type pneumatic conveying system, which may also be referred to as a suction-type elephant bionic trunk long-distance pneumatic conveying system) is provided. As shown in FIG. 4, the pneumatic conveying system comprises a second power unit 10, a second fan 11, a third connection pipeline 12, a second muffler 13, a fourth connection pipeline 14, a dust collector 15, a fifth connection pipeline 16, a negative-pressure material storage tank 17, a suction-type elephant bionic trunk conveying pipeline 18, and a suction nozzle 19.

Specifically, the second power unit 10 is configured to provide power for the second fan 11.

The second fan 11 is a power source of gas flow in the pneumatic conveying system and configured to convert kinetic energy provided by the second power unit 10 into energy of gas flow in the pneumatic conveying system.

The second fan 11 is connected to the second muffler 13 through the third connection pipeline 12, and the second muffler 13 is configured to reduce the noise generated by the second fan 11.

The outlet of the second fan 11 is connected to the fourth connection pipeline 14, the fourth connection pipeline 14 is connected to the dust collector 15, the dust connector 15 is connected to the negative-pressure material storage tank 17 through the fifth connection pipeline 16, the negative-pressure material storage tank 17 is connected to the suction-type elephant bionic trunk conveying pipeline 18, and an end of the suction-type elephant bionic trunk conveying pipeline 18 is provided with the suction nozzle 19.

The dust collector 15 is configured to filter the dust in the gas to avoid a structural damage of the second fan 11 due to the dust entering the second fan 11.

The suction nozzle 19 is configured to suction the material to be conveyed into the suction-type elephant bionic trunk conveying pipeline 18.

The negative-pressure material storage tank 17 is configured to store the material conveyed to a destination.

As some implementations, the second power unit 10 comprises, but is not limited to a power device such as an engine, a motor, or an electric motor, and may convert chemical energy, kinetic energy, electric energy, and the like into kinetic energy to drive the second fan 11 to rotate.

As some implementations, the second power unit 10 is connected to the second fan 11 through a coupling, a belt, a chain, and the like.

As some implementations, the second fan 11 comprises, but is not limited to, a Roots blower, a centrifugal fan, an axial flow fan, and the like.

As some implementations, as the structure shown in FIG. 5, the suction-type elephant bionic trunk conveying pipeline 18 is a pipeline 181 with a gradually reduced inner diameter (for example, a pipeline in a shape similar to a tapered shape). The pipeline 181 may be arranged along a straight line as needed or may also be curvedly arranged along a conveying path. The pipeline 181 has one end with a larger inner diameter connected to the negative-pressure material storage tank 17, and one end with a smaller inner diameter connected to the suction nozzle 19. With this structure, the inner diameter of the pipeline reduces, which will compress a flow space of the gas inside, alleviate or even offset a decrease of gas flow rate caused by volumetric compression of the gas due to a pressure rise, and alleviate or even offset an increase of gas flow rate caused by volumetric expansion of the gas due to a pressure drop.

It can be understood that the inner diameter of the suction-type elephant bionic trunk conveying pipeline 18 is gradually reduced, that is, the inner diameter of the suction-type elephant bionic trunk conveying pipeline 18 gradually increases from one end connected to the suction nozzle 19 to one end connected to the negative-pressure material storage tank 17.

As other implementations, the suction-type elephant bionic trunk conveying pipeline 18 is spliced by pipelines with inner diameters in different specifications according to a descending sequence in size, and has one end with a larger inner diameter is connected to the negative-pressure material storage tank 17 and one end with a smaller inner diameter is connected to the suction nozzle 19.

As other implementations, the suction-type elephant bionic trunk conveying pipeline 18 is spliced by pipelines with inner diameters in different specifications according to a descending sequence in size, and a transition pipeline in a tapered shape is provided between pipelines with inner diameters in different specifications. By adding the transition pipeline, the pipeline blockage caused by a sudden change of internal gas flow rate due to a sudden change of the inner diameter of pipelines can be alleviated.

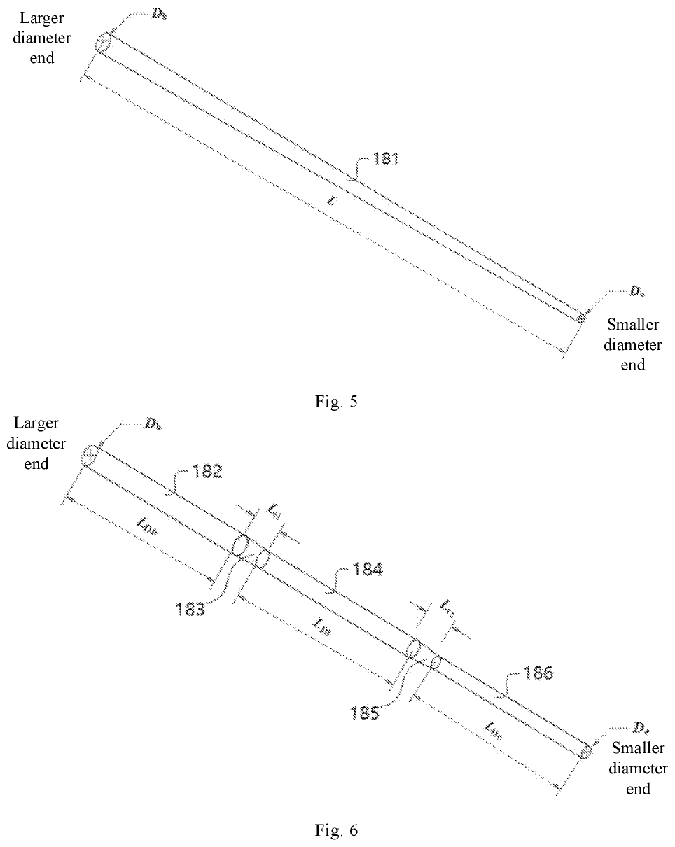

FIG. 6 illustrates a case where the diameters varied two times as an example, which shall not serve as a limitation this disclosure.

Referring to FIG. 6, the suction-type elephant bionic trunk conveying pipeline 18 is spliced by a first conveying pipeline 182, a conveying pipeline 184 and a last conveying pipeline 186 with inner diameters in different specifications according to a descending sequence in size. A first transition pipeline 183 in a tapered shape is provided at a diameter varying position between the first conveying pipeline 182 and the conveying pipeline 184, and a second transition pipeline 185 in a tapered shape is provided at a diameter varying position between the conveying pipeline 184 and the last conveying pipeline 186. The first conveying pipeline 182 is connected to the negative-pressure material storage tank 17, and the last conveying pipeline 186 is connected to the suction nozzle 19. It can be understood that the respective inner diameters of the first conveying pipeline 182, the conveying pipeline 184 and the last conveying pipeline 186 are substantially constant.

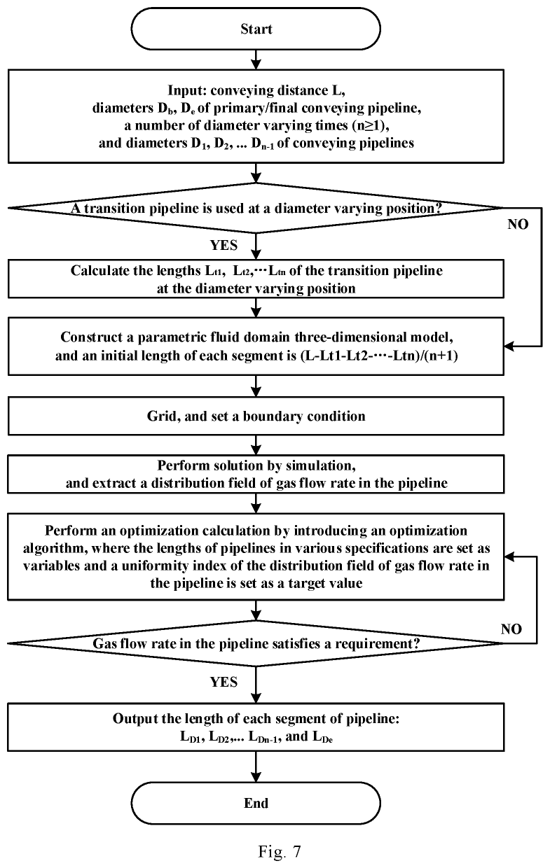

In still other embodiments of the present disclosure, an optimized configuration method of a pneumatic conveying system is provided. The method is used to optimize the configuration of an elephant bionic trunk conveying pipeline spliced by pipelines with inner diameters in different specifications in the pneumatic conveying system according to any of the above-described embodiments. As shown in FIG. 7, the method comprises the following steps.

In step 1, the parameters of the pneumatic conveying system, such as a conveying distance L, a diameter Db of a first conveying pipeline, a diameter De of a last conveying pipeline, a number of diameter varying times n (n>1), diameters D₁, D₂, . . . . Dₙ₋₁ of conveying pipelines and the like are determined.

It can be understood that, in a case where the number of diameter varying times n is equal to 1, the elephant bionic trunk conveying pipeline does not comprise a conveying pipeline between the first conveying pipeline and the last conveying pipeline. In this case, there is no need to determine the diameters D₁ to Dₙ₋₁ of the conveying pipelines.

In a case of n>2, the elephant bionic trunk conveying pipeline comprises at least one conveying pipeline between the first conveying pipeline and the last conveying pipeline. In this case, the diameters D₁ to Dₙ₋₁ of the conveying pipelines are determined.

In step 2, it is judged whether a form of a transition pipeline is used at a diameter varying position of the elephant bionic trunk conveying pipeline. In a case where the transition pipeline is used, step 3 is proceeded; and in a case where the transition pipeline is not used, step 4 is proceeded.

In step 3, the lengths Lₜ₁, Lₜ₂, . . . . Lₜₙ of the transition pipelines at each diameter varying position are calculated. The length of a transition pipeline is set to be 6 times or more of a diameter of a pipeline with a larger inner diameter in pipelines connected to this transition pipeline. Then, step 4 is proceeded.

It can be understood that both ends of the transition pipeline at each diameter varying position are respectively connected to one and the other of two pipelines with different inner diameters. The pipeline with a larger inner diameter here is a pipeline with a larger inner diameter in the two pipelines connected to both ends of the transition pipeline.

In step 4, a parametric fluid domain three-dimensional model is constructed.

In some embodiments, an initial length of each segment of the pipeline in the model may be equal to (L-Lₜ₁-Lₜ₂- . . . -Lₜₙ)/(n+1).

In step 5, the parametric fluid domain three-dimensional model is gridded, and a boundary condition of the parametric fluid domain three-dimensional model is set.

In step 6, solution is performed by using a simulation software, and a distribution field of gas flow rate in the pipeline is extracted after convergence.

In step 7, an optimization calculation is performed to output the lengths of pipelines in various specifications by introducing an optimization algorithm, where the lengths of pipelines in various specifications are set as variables, and a uniformity index of the distribution field of gas flow rate in the pipeline is set as a target value. The lengths of pipelines in various specifications are the length L_{Db} of the first conveying pipeline, the lengths L_{D1}, L_{D2}, . . . . L_{Dn-1} of the conveying pipelines between the first conveying pipeline and the last conveying pipeline, and the length L_{De} of the last conveying pipeline.

Referring to FIG. 7, in a case where the uniformity index of the distribution field of gas flow rate in the elephant bionic trunk conveying pipeline satisfies a preset requirement, the lengths of pipelines in various specifications may be output. Otherwise, the optimization calculation is continued to be performed.

It is to be noted that, the optimization algorithm in step 7 may use, but is not limited to: Bayesian optimization, genetic algorithm, gradient-based optimization, grid search, swarm-based optimization, ParamILS, Keras Tuner, and the like.

Embodiments of the present disclosure also provide an optimization configuration method of the pneumatic conveying system. The method is used to optimize the configuration of pipelines with different inner diameters in the pneumatic conveying system according to any of the above-described embodiments. The method comprises the following steps.

In step 1, a conveying distance of the pneumatic conveying system, a diameter of the first conveying pipeline, a diameter of the last conveying pipeline, a number of diameter varying times and a diameter of the at least one conveying pipeline are determined.

In step 2, it is judged whether a transition pipeline is used between pipelines with different inner diameters. In a case where the transition pipeline is used, step 3 is proceeded; and in a case where the transition pipeline is not used, step 4 is proceeded.

In step 3, a length of the transition pipeline at each diameter varying position is calculated based on the diameter of each conveying pipeline in the at least one conveying pipeline, and step 4 is proceeded.

In step 4, a parametric fluid domain three-dimensional model is constructed for an elephant bionic trunk conveying pipeline formed by pipelines with different inner diameters.

In step 5, the parametric fluid domain three-dimensional model constructed is gridded and a boundary condition is set for the parametric fluid domain three-dimensional model.

In step 6, an optimization calculation is performed on the parametric fluid domain three-dimensional model to output the lengths of pipelines with different inner diameters, taking the lengths of the pipelines with different inner diameters as variables and a uniformity index of a distribution field of gas flow rate in the elephant bionic trunk conveying pipeline as a target.

The embodiments of the present disclosure further provide a computer readable storage medium comprising computer program instructions, wherein the method according to any of the above-described embodiments is implemented when the computer program instructions are executed by a processor.

The embodiments of the present disclosure further provide a computer program product comprising a computer program, wherein the method according to any of the above-described embodiments is implemented when the computer program is executed by a processor implements.

Those skilled in the art should understand that the embodiments of the present disclosure may be provided as a method, a system, or a computer program product. Accordingly, the present disclosure may take the form of an entirely hardware embodiment, an entirely software embodiment, or a combination of software and hardware aspects. Moreover, the present disclosure may take the form of a computer program product implemented on one or more computer-usable non-transitory storage media (comprising but not limited to a disk memory, a CD-ROM, an optical memory, and the like) containing computer usable program codes.

Although some specific embodiments of the present disclosure have been described in detail by way of examples, those skilled in the art should understand that the above examples are only for the purpose of illustration but not for limiting the scope of the present disclosure. It should be understood by those skilled in the art that modifications to the above embodiments and equivalently substitution of a part of the technical features can be made without departing from the scope and spirit of the present disclosure. The scope of the present disclosure is defined by the appended claims.

Improvements without departing from the concept of the present disclosure should be regarded as falling in the protection scope of the present disclosure.

1. A pneumatic conveying system, comprising a first power unit, a first fan, a feeder, a pressure-type elephant bionic trunk conveying pipeline, a gas-material separator, and a material storage tank, wherein:
the first power unit is configured to provide power for the first fan;
the first fan is configured to convert kinetic energy provided by the first power unit into energy of gas flow in the pneumatic conveying system;
an outlet of the first fan is connected to a second connection pipeline which is connected to the pressure-type elephant bionic trunk conveying pipeline, and the pressure-type elephant bionic trunk conveying pipeline is sequentially connected to the gas-material separator and the material storage tank;
the feeder is located at connection of the second connection pipeline and the pressure-type elephant bionic trunk conveying pipeline; and
the pressure-type elephant bionic trunk conveying pipeline is a pipeline with a gradually enlarged inner diameter, wherein one end with a smaller inner diameter of the pressure-type elephant bionic trunk conveying pipeline is connected to the feeder, and one end with a larger inner diameter of the pressure-type elephant bionic trunk conveying pipeline is connected to the gas-material separator.

2. The pneumatic conveying system according to claim 1, wherein the first power unit is any one of the following:
an engine, a motor, and an electric motor.

3. The pneumatic conveying system according to claim 1, wherein the first power unit is connected to the first fan through a coupling, a belt or a chain.

4. The pneumatic conveying system according to claim 1, wherein the first fan is any one of the following:
a Roots blower, a centrifugal fan, and an axial flow fan.

5. The pneumatic conveying system according to claim 1, wherein the pressure-type elephant bionic trunk conveying pipeline is spliced by pipelines with different inner diameters according to an ascending sequence in size, wherein:
a pipeline with a smallest inner diameter is a first conveying pipeline connected to the feeder;
a pipeline with a largest inner diameter is a last conveying pipeline connected to the gas-material separator; and
at least one conveying pipeline is between the first conveying pipeline and the last conveying pipeline.

6. The pneumatic conveying system according to claim 5, wherein a transition pipeline in a tapered shape is provided at a diameter varying position between the pipelines with different inner diameters.

7. The pneumatic conveying system according to claim 1, further comprising a first muffler connected to the first fan through a first connection pipeline.

8. A pneumatic conveying system, comprising a second power unit, a second fan, a dust collector, a negative-pressure material storage tank, a suction-type elephant bionic trunk conveying pipeline, and a suction nozzle, wherein:
the second power unit is configured to provide power for the second fan;
the second fan is configured to convert kinetic energy provided by the second power unit into energy of gas flow in the pneumatic conveying system;
an outlet of the second fan is sequentially connected to the dust collector and the negative-pressure material storage tank;
the negative-pressure material storage tank is connected to the suction-type elephant bionic trunk conveying pipeline;
the suction nozzle is provided at an end of the suction-type elephant bionic trunk conveying pipeline; and
the suction-type elephant bionic trunk conveying pipeline is a pipeline with a gradually reduced inner diameter, wherein one end with a smaller inner diameter of the suction-type elephant bionic trunk conveying pipeline is connected to the suction nozzle, and one end with a larger inner diameter of the suction-type elephant bionic trunk conveying pipeline is connected to the negative-pressure material storage tank.

9. The pneumatic conveying system according to claim 8, wherein the second power unit is any one of the following:
an engine, a motor, and an electric motor.

10. The pneumatic conveying system according to claim 8, wherein the second power unit is connected to the second fan through a coupling, a belt or a chain.

11. The pneumatic conveying system according to claim 8, wherein the second fan is any one of the following:
a Roots blower, a centrifugal fan, and an axial flow fan.

12. The pneumatic conveying system according to claim 8, wherein the suction-type elephant bionic trunk conveying pipeline is spliced by pipelines with different inner diameters according to a descending sequence in size, wherein:
a pipeline with a largest inner diameter is a first conveying pipeline connected to the negative-pressure material storage tank;
a pipeline with a smallest inner diameter is a last conveying pipeline connected to the suction nozzle; and
at least one conveying pipeline is between the first conveying pipeline and the last conveying pipeline.

13. The pneumatic conveying system according to claim 12, wherein a transition pipeline in a tapered shape is provided at a diameter varying position between the pipelines with different inner diameters.

14. The pneumatic conveying system according to claim 8, further comprising a second muffler connected to the second fan through a third connection pipeline.

15. An optimized configuration method of a pneumatic conveying system according to claim 5, for performing an optimized configuration of the pipelines with different inner diameters in the pneumatic conveying system, the optimized configuration method comprising:
step 1: determining a conveying distance of the pneumatic conveying system, a diameter of the first conveying pipeline, a diameter of the last conveying pipeline, a number of diameter varying times and a diameter of the at least one conveying pipeline;
step 2: judging whether a transition pipeline is used at a diameter varying position between the pipelines with different inner diameters, proceeding to step 3 in a case where the transition pipeline is used, and proceeding to step 4 in a case where the transition pipeline is not used;
step 3: calculating a length of the transition pipeline at the diameter varying position based on the diameter of each conveying pipeline in the at least one conveying pipeline, and proceeding to step 4;
step 4: constructing a parametric fluid domain three-dimensional model of an elephant bionic trunk conveying pipeline formed by the pipelines with different inner diameters;
step 5: griding the parametric fluid domain three-dimensional model constructed and setting a boundary condition for the parametric fluid domain three-dimensional model; and
step 6: performing an optimization calculation on the parametric fluid domain three-dimensional model taking lengths of the pipelines with different inner diameters as variables and a uniformity index of a distribution field of gas flow rate in the elephant bionic trunk conveying pipeline as a target, to output the lengths of the pipelines with different inner diameters.

16. The optimized configuration method of a pneumatic conveying system according to claim 15, wherein the calculating a length of the transition pipeline at the diameter varying position based on the diameter of each conveying pipeline in the at least one conveying pipeline comprises:
setting the length of the transition pipeline at the diameter varying position to be 6 times or more of a diameter of a conveying pipeline with a larger inner diameter in conveying pipelines connected to the transition pipeline at the diameter varying position.

17. The optimized configuration method of a pneumatic conveying system according to claim 15, wherein the performing an optimization calculation on the parametric fluid domain three-dimensional model comprises:
performing the optimization calculation on the parametric fluid domain three-dimensional model by any of the following methods until the uniformity index of the distribution field of gas flow rate in the elephant bionic trunk conveying pipeline satisfies a preset requirement:
Bayesian optimization, genetic algorithm, gradient-based optimization, grid search, swarm-based optimization, ParamILS, and Keras Tuner.

18. A non-transitory computer-readable storage medium, comprising computer program instructions, wherein the optimized configuration method according to claim 15 is implemented when the computer program instructions are executed by a processor.

19. (canceled)

20. An optimized configuration method of a pneumatic conveying system according to claim 12, for performing an optimized configuration of the pipelines with different inner diameters in the pneumatic conveying system, the optimized configuration method comprising:
step 1: determining a conveying distance of the pneumatic conveying system, a diameter of the first conveying pipeline, a diameter of the last conveying pipeline, a number of diameter varying times and a diameter of the at least one conveying pipeline;
step 2: judging whether a transition pipeline is used at a diameter varying position between the pipelines with different inner diameters, proceeding to step 3 in a case where the transition pipeline is used, and proceeding to step 4 in a case where the transition pipeline is not used;
step 3: calculating a length of the transition pipeline at the diameter varying position based on the diameter of each conveying pipeline in the at least one conveying pipeline, and proceeding to step 4;
step 4: constructing a parametric fluid domain three-dimensional model of an elephant bionic trunk conveying pipeline formed by the pipelines with different inner diameters;
step 5: griding the parametric fluid domain three-dimensional model constructed and setting a boundary condition for the parametric fluid domain three-dimensional model; and
step 6: performing an optimization calculation on the parametric fluid domain three-dimensional model taking lengths of the pipelines with different inner diameters as variables and a uniformity index of a distribution field of gas flow rate in the elephant bionic trunk conveying pipeline as a target, to output the lengths of the pipelines with different inner diameters.

21. The optimized configuration method of a pneumatic conveying system according to claim 20, wherein the calculating a length of the transition pipeline at the diameter varying position based on the diameter of each conveying pipeline in the at least one conveying pipeline comprises:
setting the length of the transition pipeline at the diameter varying position to be 6 times or more of a diameter of a conveying pipeline with a larger inner diameter in conveying pipelines connected to the transition pipeline at the diameter varying position.
